(19) United States
(12) Patent Application Publication
(10) Pub. No.: US 2009/0017278 A1
(43) Pub. Date: Jan. 15, 2009

(54) Ink-Jet Printing Using Disazo Dyes

(76) Inventor: Rachel Anne James, Manchester (GB)

Correspondence Address: MORGAN LEWIS & BOCKIUS LLP, 1111 PENNSYLVANIA AVENUE NW, WASHINGTON, DC, 20004, US

(21) Appl. No.: 12/086,981

(22) PCT Filed: Dec. 18, 2006
(86) PCT No.: PCT/GB2006/004766

§ 371 Date: Jun. 23, 2008

(30) Foreign Application Priority Data
Feb. 10, 2006 (GB) 0602687.6

(51) Int. Cl. B41J 2/175; C09D 11/02; B05D 5/00; B32B 3/10

(52) U.S. Cl. 428/211.1; 347/86; 106/31.48; 427/256

(57) ABSTRACT

Compounds of Formula (1) and dimers thereof:

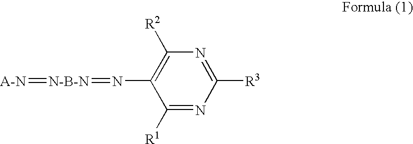

wherein:
A and B independently are optionally substituted aryl or optionally substituted heteroaryl groups;
R¹ and R² are each independently optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl;
R³ is optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl;
also ink-jet inks and processes and printed materials.

This invention relates to, ink-jet printing processes, compositions and inks, compounds, printed substrates and to ink-jet printer cartridges.

Ink-jet printing is a non-impact printing technique in which droplets of ink are ejected through a fine nozzle onto a substrate without bringing the nozzle into contact with the substrate. The set of inks used in this technique typically comprise yellow, magenta, cyan and black inks. However as printer manufacturers strive for ever more realistic printed images ink-sets are being developed comprising additional coloured inks such as orange inks.

With the advent of high-resolution digital cameras and ink-jet printers it is becoming increasingly common for consumers to print off photographs using an ink-jet printer. This avoids the expense and inconvenience of conventional silver halide photography and provides a print quickly and conveniently.

While ink-jet printers have many advantages over other forms of printing and image development there are still technical challenges to be addressed. For example, there are the contradictory requirements of providing ink colorants that are soluble in the ink medium and yet do not run or smudge excessively when printed on paper. The inks need to dry quickly to avoid sheets sticking together after they have been printed, but they should not form a crust over the tiny nozzle used in the printer. Storage stability is also important to avoid particle formation that could block the tiny nozzles used in the printer especially since consumers can keep an ink-jet ink cartridge for several months with only intermittent use. Furthermore, and especially important with photographic quality reproductions, the resultant images should not fade rapidly on exposure to light or common oxidising gases such as ozone.

We have found that certain disazo 1,3-pyrimidine compounds provide orange colorants which are particularly suitable for use in ink-jet printing.

According to the present invention there is provided a process for printing an image on a substrate by means of an ink-jet printer which comprises applying thereto a composition comprising a liquid medium and a disazo compound of Formula (1), or a salt thereof, or a dimer of said disazo compound of Formula (2), or a salt thereof:

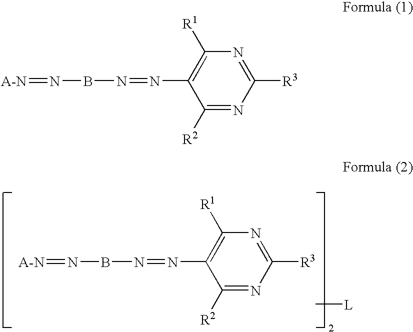

wherein:
A and B independently are optionally substituted aryl or optionally substituted heteroaryl groups;
R¹ and R² are each independently optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl;
R³ is optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl; and
L is a divalent linking group that is covalently attached to A, B, R¹ or R³.

The ink-jet printer preferably applies the ink to the substrate in the form of droplets that are ejected through a small orifice onto the substrate. Preferred ink-jet printers are piezoelectric ink-jet printers and thermal ink-jet printers. In thermal ink-jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink-jet printers the oscillation of a small crystal causes ejection of the ink from the orifice. Alternately the ink can be ejected by an electromechanical actuator connected to a moveable paddle or plunger, for example as described in International Patent Application WO00/48938 and International Patent Application WO00/55089.

The substrate is preferably paper, plastic, a textile, metal or glass, more preferably paper, an overhead projector slide or a textile material, especially paper.

Preferred papers are plain, treated or coated papers which may have an acid, alkaline or neutral character. Glossy papers are especially preferred.

Photographic quality papers are particularly favoured.

Examples of commercially available treated papers include HP Premium Coated Paper, HP Photopaper™ (both available from Hewlett Packard Inc.); Stylus™ Pro 720 dpi Coated Paper, Epson Photo Quality™ Glossy Film, Epson Photo Quality™0 Glossy Paper (all available from Seiko Epson Corp.); Canon HR 101 High Resolution™ Paper, Canon GP 201 Glossy™ Paper, Canon HG 101and HG201 High Gloss™ Film, Canon PR101 (all available from Canon); Kodak Premium™ Photopaper, Kodak Premium™ InkJetpaper (available from Kodak); Konica Inkjet Paper QP™ Professional Photo Glossy, Konica Inkjet Paper QP™ Professional Photo 2-sided Glossy, Konica Inkjet Paper QP™ Premium Photo Glossy, Konica Inkjet Paper QP™ Premium Photo Silky (available from Konica).

When L is linked through any one of A, B, R¹ or R³ then the A, B, R¹ or R³ linking group will be the equivalent divalent radical of any of the groups described below for A, B, R¹ or R³.

Preferably when A and B are optionally substituted aryl they independently are optionally substituted phenyl or optionally substituted napthyl.

When A and B are optionally substituted heteroaryl they are independently preferably selected from the group consisting of the following optionally substituted rings; pyrrolyl, furyl, thienyl, pyrazolyl, imidazolyl, triazolyl, thiazolyl, thiadiazolyl, pyridyl, pyrimidinyl or pyrazinyl.

Preferably A and/or B carry at least one water solubilising group, especially an acid group and more especially a water solubilising group selected from the group consisting of —SO₃H, —CO₂H and —PO₃H₂. The water solubilising group may be bound directly to the optionally substituted aryl or optionally substituted heteroaryl ring or it may be carried on another substituent, preferably the water solubilising group is bound directly to the aryl or heteroaryl ring.

Most preferably A is optionally substituted phenyl or optionally substituted heteroaryl, especially optionally substituted triazolyl, carrying at least one substituent selected from the group consisting of —SO₃H and —CO₂H, especially —SO₃H.

Most preferably B is optionally substituted phenyl or optionally substituted napthyl carrying at least one substituent selected from the group consisting of alkoxy, thioether, —PO₃H₂, —SO₃H and —CO₂H, especially —SO₃H and —CO₂H.

Examples of preferred phenyl and naphthyl groups represented by A and B are 2,5-disulfophenyl, 3,5-disulfophenyl, 1,5-disulfo-7-naphthyl, 1,3,6-trisulfo-7-riaphthyl, 2-sulfo4-methoxyphenyl, 2-sulfophenyl, 4-sulfophenyl and 3-sulfo-5-naphthyl.

R¹, R² and R³ are preferably each independently: halo, especially fluoro or chloro; amino; —NR⁴R⁵; wherein R⁴ is H, optionally substituted C₁₋₄alkyl, optionally substituted C₁₋₄alkoxy, optionally substituted C₁₋₄acyl, optionally substituted phenyl, especially phenyl substituted with at least one substituent selected from the group consisting of —SO₃H, —CO₂H, —PO₃H₂, optionally substituted heterocyclyl; and R⁵ is optionally substituted C₁₋₄alkyl, optionally substituted C₁₋₄alkoxy, optionally substituted C₁₋₄acyl, optionally substituted phenyl especially phenyl substituted with at least one substituent selected from the group consisting of —SO₃H, —CO₂H, —PO₃H₂, optionally substituted heterocyclyl or R⁴ together with R⁵ and the nitrogen to which they are attached forms an optionally substituted 5 or 6 membered ring: —OR⁶; wherein R⁶ is H or optionally substituted C₁₋₄alkyl: or —SR⁷; wherein R⁷ is C₁₋₄alkyl.

It is especially preferred that R¹, R² and R³ are each independently: chloro; amino; NHR⁵ wherein R⁵ is optionally substituted C₁₋₄alkyl, optionally substituted C₁₋₄acyl, phenylsubstituted with at least one substituent selected from the group consisting of —SO₃H and —CO₂H or R⁴ together with R⁵ and the nitrogen to which they are attached forms an optionally substituted 5 membered ring; —OR⁶; wherein R ⁶is H or optionally substituted C₁₋₄alkyl.

Preferably R¹ is amino or —NR⁴R⁵; wherein R⁴ is H, optionally substituted C₁₋₄alkyl, optionally substituted C₁₋₄alkoxy, optionally substituted C₁₋₄acyl.

Preferably R² is amino; —NR⁴R⁵; wherein R⁴ is H, optionally substituted C₁₋₄alkyl, optionally substituted C₁₋₄alkoxy, optionally substituted C₁₋₄acyl; —OR⁶, wherein R⁶ is H or optionally substituted C₁₋₄alkyl; —SR⁷, wherein R⁷ is C₁₋₄alkyl; or chloro.

Preferably R³ is amino; —NR⁴R⁵; wherein R⁴ is H, optionally substituted C₁₋₄alkyl, optionally substituted C₁₋₄alkoxy, optionally substituted C₁₋₄acyl; —OR⁶, wherein R⁶ is H or optionally substituted C₁₋₄alkyl; —SR⁷, wherein R⁷ is C₁₋₄alkyl; or chloro.

When the process utilises a dimer of Formula (2) then the two disazo compounds of Formula (1) may be the same or different, preferably they are the same.

L is preferably is selected from the group comprising: divalent alkyl; divalent aryl; divalent heterocyclyl; —CO—; —NHCONH—; a group of formula: —CO—R⁹—CO—; —CO—NH—R⁹—NH—CO—; —SO₂—R⁹—SO₂—; —SO₂—NH—R⁹—NH—SO₂—; or —NR¹⁰—R⁹—NR¹⁰—; wherein R⁹ is divalent alkylene or divalent arylene optionally bearing substituents selected from the group comprising alkoxy, sulfo, carboxy, hydroxy and amino and R¹⁰ is H, alkyl, aryl or heterocyclyl optionally bearing a substituent preferably selected from the group comprising alkoxy, sulfo, carboxy, hydroxy and amino.

In one preferred embodiment L comprises one or more groups of formula:

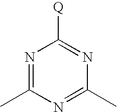

wherein: Q is NR¹¹R¹², SR¹¹ or OR¹¹ and R¹¹ and R¹² are independently H, optionally substituted alkyl, optionally substituted aryl or optionally substituted heterocyclyl where the substituent is preferably selected from the group comprising alkoxy, sulfo, carboxy, hydroxy and amino.

Optional substituents which present on any one of R¹ to R¹², A, B or L may be independently selected from: optionally substituted alkyl (preferably C₁₋₄-alkyl), optionally substituted alkoxy (preferably C₁₋₄-alkoxy), optionally substituted aryl (preferably phenyl), optionally substituted aryloxy (preferably phenoxy), optionally substituted heterocyclyl, polyalkylene oxide (preferably polyethylene oxide or polypropylene oxide), —PO₃H₂, —CO₂H, nitro, —CN, halo, ureido, —SO₃H, —SO₂F, hydroxy, ester, —NR^{a}R^{b}, —COR^{a}, —CONR^{a}R^{b}, —NHCOR , carboxyester, sulfone, and —SO₂NR^{a}R^{b}, wherein R^{a} and R^{b} are each independently H or optionally substituted alkyl (especially C₁₋₄-alkyl). Optional substituents for any of the substituents described above may be selected from the same list of substituents.

Preferred optional substituents independently present on any one of R¹ to R¹², A, B or L are selected from —OH, alkyl, —CO₂H, —SO₃H and —CN.

One preferred process of the present invention utilises a disazo compound of Formula (3) and salts thereof:

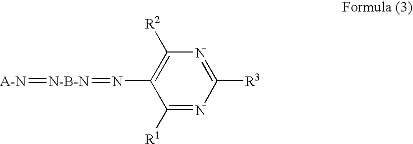

wherein:
A and B independently are optionally substituted aryl or optionally substituted heteroaryl groups wherein both A and B independently carry at least one water solubilising substituent selected from the group consisting of —SO₃H, —CO₂H, —PO₃H₂, and alkoxy: and
R¹ and R² are each independently optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl;
R³ is optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl;
provided that the compound is not of the formula

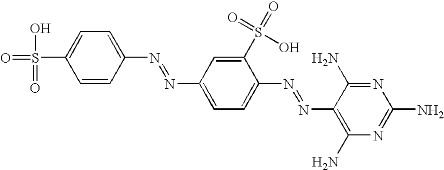

Compounds of Formula (1) and Formula (2) are preferably free from fibre reactive groups. The term fibre reactive group is well known in the art and is described for example in EP 0356014 A1. Fibre reactive groups are capable, under suitable conditions, of reacting with the hydroxyl groups present in cellulosic fibres or with the amino groups present in natural fibres to form a covalent linkage between the fibre and the dye. As examples of fibre reactive groups -preferably not present in the compounds of the first aspect of the present invention there may be mentioned aliphatic sulfonyl groups which contain a sulfate ester group in the beta-position to the sulfur atom, e.g. beta-sulfato-ethylsulfonyl groups, alpha, beta-unsaturated acyl radicals of aliphatic carboxylic acids, for example acrylic acid, alpha-chloro-acrylic acid, alpha-bromoacrylic acid, propiolic acid, maleic acid and mono- and dichloro maleic; also the acyl radicals of acids which contain a substituent which reacts with cellulose in the presence of an alkali, e.g. the radical of a halogenated aliphatic acid such as chloroacetic acid, beta-chloro and beta-bromopropionic acids and alpha, beta-dichloro- and dibromopropionic acids or radicals of vinylsulfonyl- or beta-chloroethylsulfonyl- or beta-sulfatoethyl-sulfonyl-endo-methylene cyclohexane carboxylic acids. Other examples of cellulose reactive groups are tetrafluorocyclobutyl carbonyl, trifluoro-cyclobutenyl carbonyl, tetrafluorocyclobutylethenyl carbonyl, trifluoro-cyclobutenylethenyl carbonyl; activated halogenated 1,3-dicyanobenzene radicals; and heterocyclic radicals which contain 1, 2 or 3 nitrogen atoms in the heterocyclic ring and at least one cellulose reactive substituent on a carbon atom of the ring.

When compounds of Formula (1) or Formula (2) are in the form of a salt the preferred salts are alkali metal salts (especially lithium, sodium and potassium salts), ammonium and substituted ammonium salts and mixtures thereof. Especially preferred salts are sodium, potassium and lithium salts, salts with ammonia and volatile amines and mixtures thereof.

The compounds may be converted into a desired salt using known techniques. For example, an alkali metal salt of a compound may be converted into the ammonium or substituted ammonia salt by dissolving an alkali metal salt of the compound in water, acidifying with a mineral acid and adjusting the pH of the solution to pH 9 to 9.5 with ammonia or the amine and removing the alkali metal cations by dialysis or by use of an ion exchange resin.

Preferably the compounds of Formula (1) and Formula (2) have a solubility in water at 25° C. of at least 1%, more preferably of at least 2% and especially of at least 5%

The compounds of Formula (1) and Formula (2), as described herein, may exist in tautomeric forms other than those shown in this specification. These tautomers are also included within the scope of the present inventions.

The compounds of Formula (1) and Formula (2) have attractive, strong orange shades and are valuable colorants for use in the preparation of ink-jet printing inks. They benefit from a good balance of solubility, storage stability and fastness to water ozone and light.

The compounds of Formula (1) may be prepared by diazotising a compound of formula A—N═N—B—NH₂, wherein A and B are as hereinbefore defined, to give a diazonium salt and coupling the resultant diazonium salt with a compound of Formula (4) wherein R¹, R² and R³ are as hereinbefore defined:

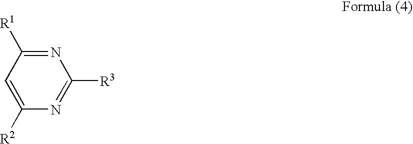

The compounds of formula A—N═N—B—NH₂ may be prepared by diazotising a compound of formula A—NH₂ to give a diazonium salt and coupling the resultant diazonium salt with a compound of formula B—NH₂ wherein A and B are as hereinbefore defined.

Many compounds of Formula (4) are commercially available others may be prepared using synthetic protocols which would be well known to one of ordinary skill.

When L is a divalent linker covalently attached to R¹ the compounds of Formula (2) may be prepared by diazotising a compound of formula A—N═N—B—NH₂ wherein A and B are as hereinbefore defined to give a diazonium salt and coupling the resultant diazonium salt with a compound of Formula (5) wherein L, R¹, R² and R³ are as hereinbefore defined:

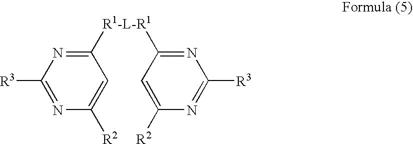

When L is a divalent linker covalently attached to R³ the compounds of Formula (2) may be prepared by diazotising a compound of formula A—N═N—B—NH₂ wherein A and B are as hereinbefore defined to give a diazonium salt and coupling the resultant diazonium salt with a compound of Formula (6) wherein L, R¹, R² and R³ are as hereinbefore defined:

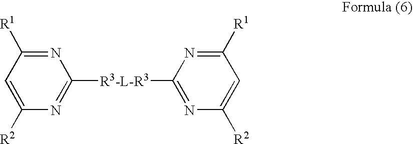

When L is a divalent linker covalently attached to A or B the compounds of Formula (2) may be prepared by diazotising a compound of Formula (7), wherein A, B and L are as hereinbefore defined to give a diazonium salt and coupling the resultant diazonium salt with a compound of Formula (6) wherein R¹, R² and R³ are as hereinbefore defined.

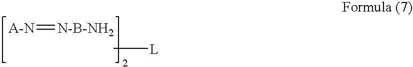

Compounds of Formula (7) may be prepared by tetrazotising a compound of Formula (8) to give a bis-diazonium salt and coupling the resultant bis-diazonium salt with a compound of Formula BNH₂. Wherein A, B, and L are as hereinbefore defined.

NH₂—A—L—A—NH₂ Formula (8)

Alternatively the compounds of Formula (7) may be prepared by diazotising a compound of formula ANH₂ to give a diazonium salt and coupling the resultant diazonium salt with a compound of Formula (9), wherein A, B, and L are as hereinbefore defined.

NH₂—B—L—B—NH₂ Formula (9)

Compounds of Formula (8) or (9) wherein L comprises a triazine may be prepared, by way of example, by the condensation of two equivalents of a compound of formula A(NH₂)₂ or of formula B(NH₂)₂ with one equivalent of cyanuric chloride followed by the reaction of the resultant mono chloro compound with a compound of formula QH, wherein Q is as hereinbefore defined.

Compounds of Formula (5) wherein L comprises an alkylene group may be prepared, by way of example, by the condensation of two equivalents of an optionally substituted pyrimidine compound wherein R¹ (or R²) comprises chloro with one equivalent of a diamino alkane.

Compounds of Formula (6) wherein L comprises an alkylene group may be prepared, by way of example, by the condensation of two equivalents of an optionally substituted pyrimidine compound wherein R ³ comprises a thiol group with one equivalent of a dibromo alkane.

All diazotisation are preferably performed at a temperature of 0° C. to 10° C. Preferably diazotisations are performed in water, preferably at a pH below 7. Dilute mineral acid, e.g. HCl or H₂SO₄, may be used to achieve the desired pH conditions.

Reaction conditions are those generally used in the dyestuff art, for example as described in EP 0356080.

The liquid medium used in the process of the present invention may comprise water, a mixture of water and organic solvent or organic solvent free from water.

When the liquid medium comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide and sulfolane. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

Examples of further suitable liquid media comprising a mixture of water and one or more organic solvents are described in U.S. Pat. No. 4,963,189, U.S. Pat. No. 4,703,113, U.S. Pat. No. 4,626,284 and EP-A-425,150.

When the liquid medium comprises organic solvent free from water, (i.e. less than 1% water by weight) the solvent preferably has a boiling point of from 30° to 200° C., more preferably of from 40° to 150° C., especially from 50 to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the dye in the liquid medium. Examples of polar solvents include C₁₋₄-alcohols.

In view of the foregoing preferences it is especially preferred that where the liquid 5 medium is organic solvent free from water it comprises a ketone (especially methyl ethyl ketone) &/or an alcohol (especially a C₁₋₄-alkanol, more especially ethanol or propanol).

The organic solvent free from water may be a single organic solvent or a mixture of two or more organic solvents. It is preferred that when the liquid medium is organic solvent free from water it is a mixture of 2 to 5 different organic solvents. This allows a liquid medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid medium may of course contain additional components conventionally used in ink-jet printing inks, for example viscosity and surface tension modifiers, corrosion inhibitors, biocides, kogation reducing additives and surfactants which may be ionic or non-ionic.

Usually only one colourant of Formula (1) or Formula (2) will be used in the composition. However, different compounds of Formula (1) and/or Formula (2) may be mixed in the composition.

Although not usually necessary, further colorants may be added to the composition/ink to modify the shade and performance properties. Examples of such colorants include C.I. Direct Yellow 86, 132, 142 and 173; C.I. Direct Blue 307; C.I. Food Black 2; C.I. Direct Black 168 and 195; C.I. Acid Yellow 23.

It is preferred that the composition used in the process of the invention is ink suitable for use in an ink-jet printer. Ink suitable for use in an ink-jet printer is ink which is stable in an ink-jet cartridge over several months and able to repeatedly fire through an ink-jet printing head without causing blockage of the fine nozzles.

Ink suitable for use in an ink-jet printer preferably has a viscosity of less than 20 cP, more preferably less than 10 cP, especially less than 5 cP, at 25° C.

The surface tension of ink suitable for use in an ink-jet printer is preferably in the range 20-65 dynes/cm, more preferably in the range 30-60 dynes/cm, at 25° C.

Ink suitable for use in an ink-jet printer preferably contains less than 500 ppm, more preferably less than 250 ppm, especially less than 100 ppm, more especially less than 10 ppm in total of divalent and trivalent metal ions (other than any divalent and trivalent metal ions bound to a colorant of Formula (1) or Formula (2) or any other component of the ink).

Preferably ink suitable for use in an ink-jet printer has been filtered through a filter having a mean pore size below 10 μm, more preferably below 3 μm, especially below 2 μm, more especially below 1 μm. This filtration removes particulate matter that would otherwise block the fine nozzles found in many ink-jet printers.

Preferably ink suitable for use in an ink-jet printer contains less than 500 ppm, more preferably less than 250 ppm, especially less than 100 ppm, more especially less than 10 ppm in total of halide, particularly chloride, ions.

Preferred compositions comprise:

(a) from 0.01 to 30 parts of dyes of Formula (1) and/or Formula (2); and

(b) from 70 to 99.99 parts of a liquid medium; wherein all parts are by weight.

Preferably the number of parts of (a)+(b)=100.

The number of parts of component (a) is preferably from 0.1 to 20, more preferably from 0.5 to 15, and especially from 1 to 5 parts. The number of parts of component (b) is preferably from 80 to 99.9, more preferably from 85 to 99.5 and especially from 95 to 99 parts.

Preferably component (a) is completely dissolved in component (b). Preferably component (a) has a solubility in component (b) at 20° C. of at least 10%. This allows the preparation of liquid dye concentrates that may be used to prepare more dilute inks and reduces the chance of the dye precipitating if evaporation of the liquid medium occurs during storage.

The inks may be incorporated in an ink-jet printer as a high concentration ink, a low concentration ink or both a high concentration and a low concentration ink. In the latter case this can lead to improvements in the resolution and quality of printed images. Thus, the present invention also provides a composition (preferably an ink) where component (a) is present in an amount of 2.5 to 7 parts, more preferably 2.5 to 5 parts (a high concentration ink) or component (a) is present in an amount of 0.5 to 2.4 parts, more preferably 0.5 to 1.5 parts (a low concentration ink).

The pH of the composition is preferably from 4 to 11, more preferably from 7 to 10.

According to second aspect of the invention there is provided a composition comprising a compound of Formula (1) or Formula (2) as defined in the first aspect of the invention and a liquid medium which comprises a mixture of water and organic solvent or organic solvent free from water.

In the second aspect of the invention the composition, the compounds of Formula (1) and Formula (2), the organic solvent in the mixture of water and organic solvent and the organic solvent free from water are as described and preferred in the first aspect of the invention.

It is especially preferred that the composition according to the second aspect of the invention is ink suitable for use in an inkjet printer, as defined in the first aspect of the invention.

According to a third aspect of the invention there is provided a disazo compound of Formula (1) and salts thereof:

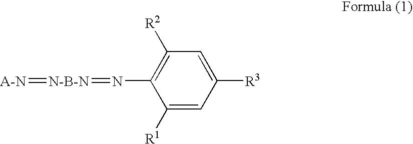

wherein:
A and B independently are optionally substituted aryl or optionally substituted heteroaryl groups wherein both A and B independently carry at least one water solubilising substituent selected from the group consisting of —SO₃H, —CO₂H, —PO₃H₂, and alkoxy: and
R¹ and R² are each independently optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl;
R³ is optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is optionally substituted alkyl: or —SR⁷; wherein R⁷ is optionally substituted alkyl;
provided that the compound is not of the formula

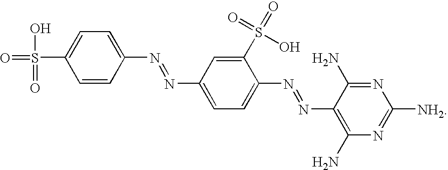

Preferences for A, B, L, R¹, R² and R³ are as described in the first aspect of the invention where said preferences are within the scope of the third aspect of the invention.

A fourth aspect of the invention provides a composition comprising a compound of Formula (1), as defined in the third aspect of the invention, or a salt thereof and water.

The aqueous compositions are as described and preferred in the first aspect of the invention and the compound of Formula (1) is as described and preferred in the third aspect of the invention.

A fifth aspect of the invention provides a compound of Formula (2) and salts thereof:

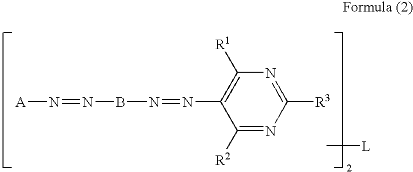

wherein:
A and B independently are optionally substituted aryl or optionally substituted heteroaryl groups;
R¹ and R² are each independently optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl;
R³ is optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is optionally substituted alkyl: or —SR⁷; wherein R⁷ is optionally substituted alkyl; and
L is a divalent linking group that is covalently attached to A, B, R¹ or R³.

Preferences for R¹, R², R³, A, B and L in the compound of Formula (2) in the fifth aspect of the invention are as described in the first aspect of the invention.

A sixth aspect of the invention provides a composition comprising a compound of Formula (2), as defined in the fifth aspect of the invention, or a salt thereof and water.

A seventh aspect of the present invention provides a material preferably paper, plastic, a textile, metal or glass, more preferably paper, an overhead projector slide or a textile material, especially paper more especially plain, coated or treated papers printed with a compound as described in the third and fifth aspects of the invention, a composition as described in the second, fourth or sixth aspect of the invention or by means of a process as described in the first aspect of the invention.

It is especially preferred that the printed material of the seventh aspect of the invention is a print on a photographic quality paper printed using a process as described in the first aspect of the invention.

An eighth aspect of the present invention provides an ink-jet printer cartridge comprising a chamber and an ink suitable for use in an ink-jet printer wherein the ink is in the chamber and the ink is as defined in the second, fourth or sixth aspects of the present invention. It is especially preferred that the inks in the chamber is an ink suitable for ink-jet printing as described in the first aspect of the invention. The cartridge may contain a high concentration ink and a low concentration ink, as described in the second aspect of the invention, in different chambers.

The present compounds and compositions provide prints of attractive orange shades that are particularly well suited for the ink-jet printing of text and images. The compositions have good storage stability and a low tendency to block the very fine nozzles used in ink-jet printers. Furthermore, the resultant images have excellent optical density, shade, light-fastness, wet-fastness, humidity fastness and resistance to fading in the presence of oxidising air pollutants.

The invention is further illustrated by the following Examples in which all parts and percentages are by weight unless specified otherwise.

### EXAMPLE 1

### Preparation of:

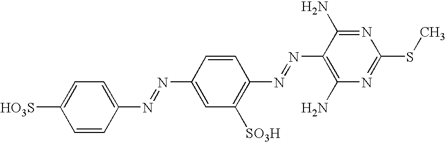

4-Amino-1,1′-azobenzene-3,4′-disulfonic acid, from Aldrich, (0.05 mol, 18.9 g) was dissolved in water (500 mL) by the addition of sodium hydroxide solution and then cooled to 0-5° C. Concentrated hydrochloric acid (20 mL) was then added followed by the dropwise addition of a 1M sodium nitrite solution (0.055 mol, 55 ml). The solution was stirred for 1 h to allow complete formation of the diazonium salt. After this time excess nitrous acid was quenched by the addition of sulfamic acid.

Separately, 2-(methylthio)pyrimidine-4,6-diamine, from. Acros Organics, (0.05 mol, 7.8 g) was dissolved in a mixture of ethanol (200 ml) and water (100 ml) and cooled to 0-5° C. The diazonium solution, prepared above, was then gradually added over the course of 20 mins while the pH was maintained at 4 to 5 by the addition of sodium acetate. The reaction mixture was allowed to warm to room temperature and then stirred for a further 4 h. The product was precipitated by the addition of NaCl (40 g) and collected by filtration. The precipitate was re-dissolved in water (300 ml), dialysed to <100 μs and then dried at 60° C. to provide the pure product as a yellow solid.

### EXAMPLE 2

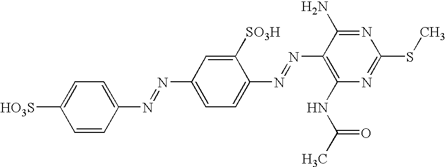

The compound of Example 2 was prepared by the process of Example 1 except that 2-(methylthio)pyrimidine4,6-diamine was replaced with N-[6-amino-2-(methylthio)pyrimidin-4-yl]acetamide.

### EXAMPLE 3

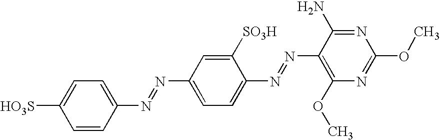

The compound of Example 3 was prepared by the process of Example 1 except that 2-(methylthio)pyrimidine4,6-diamine was replaced with 2,6-dimethoxypyrimidine4-amine.

### EXAMPLE 4

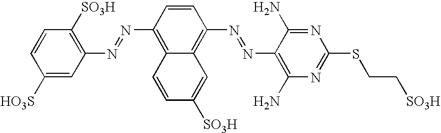

The compound of Example 4 was prepared by the process of Example 1 except that 4-amino-1,1′-azobenzene-3,4′-disulfonic acid was replaced with 2-[(E)-(4amino-6-sulfo-1-naphthyl)diazenyl]benzene-1,4-disulfonic acid and 2-(methylthio)pyrimidine-4,6-diamine was replaced with 2-[4,6-diaminopyrimidine-2-yl)thio]ethanesulfonic acid.

### EXAMPLE 5

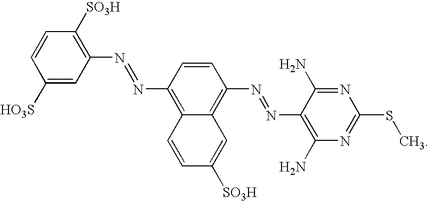

The compound of Example 5 was prepared by the process of Example 1 except that 4-amino-1,1′-azobenzene-3,4′-disulfonic acid was replaced with 2-[(E)-(4amino-6-sulfo-1-naphthyl)diazenyl]benzene-1,4-disulfonic acid.

### EXAMPLE 6

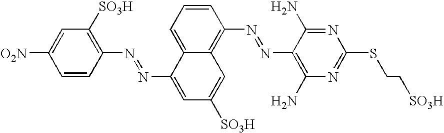

The compound of Example 6 was prepared by the process of Example 1 except that 4-amino-1,1′-azobenzene-3,4′-disulfonic acid was replaced with 8-amino-5-[(E)-(4-nitro-2-sulfophenyl)diazenyl]naphthalene-2-sulfonic acid and 2-(methylthio)pyrimidine4,6-diamine was replaced with 2-[4,6-diaminopyrimidine-2-yl)thio]ethanesulfonic acid.

### EXAMPLE 7

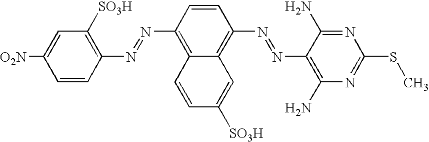

The compound of Example 7 was prepared by the process of Example 1 except that 4-amino-1,1′-azobenzene-3,4′-disulfonic acid was replaced with 8-amino-5-[(E)-(4-nitro-2-sulfophenyl)diazenyl]naphthalene-2-sulfonic acid.

### EXAMPLE 8

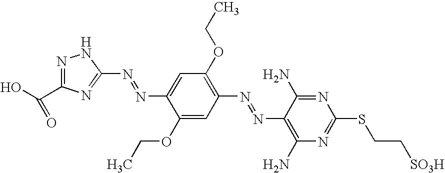

The compound of Example 8 was prepared by the process of Example 1 except that 4-amino-1,1′-azobenzene-3,4′-disulfonic acid was replaced with 5-[(E)-(4-amino-2,5-diethoxyphenyl)diazenyl]-1H-1,2,4-triazole-3-carboxylic acid and 2-(methylthio)pyrimidine-4,6-diamine was replaced with 2-[4,6-diaminopyrimidine-2-yl)thio]ethanesulfonic acid.

### EXAMPLE 9

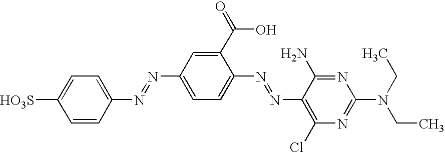

The compound of Example 9 was prepared by the process of Example 1 except that 4-amino-1,1′-azobenzene-3,4′-disulfonic acid was replaced with 2-amino-5-[(E)-(4-sulfophenyl)diazenyl]benzoic acid and 2-(methylthio)pyrimidine4,6-diamine was replaced with 6-chloro-2-diethylamino4-aminopyrimidine.

### EXAMPLE 10

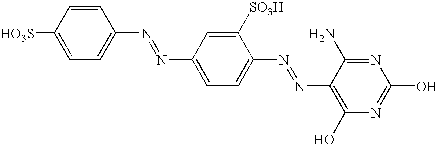

The compound of Example 10 was prepared by the process of Example 1 except that 2-(methylthio)pyrimidine-4,6-diamine was replaced with 6-aminopyrimidine-2,4-diol.

### Inks And Ink-Jet Printing

Inks may be prepared by dissolving 3 g of the compounds of Examples 1 to 10 in 97 ml of a liquid medium consisting of 5 parts 2-pyrrolidone; 5 parts thiodiethylene glycol; 1 part Surfynol™ 465 and 89 parts water and adjusting the pH to between pH 8 to 9 with sodium hydroxide. Surfynol™ 465 is a surfactant from Air Products.

### Ink-Jet Printing

Inks, prepared as described above, should then be filtered through a 0.45 micron nylon filter and may then be incorporated into empty print cartridges using a syringe.

These inks can be printed onto either plain paper or a specialist ink-jet medium.

### Print Evaluation

Prints can be tested for ozone fastness by exposure to 1 ppm ozone at 40° C., 50% relative humidity, for 24 hrs in a Hampden 903 Ozone cabinet. Fastness of the printed ink to ozone can be judged by the difference in the optical density before and after exposure to ozone.

Light-fastness of the printed image may be assessed by fading the printed image in an Atlas Ci5000 Weatherometer for 100 hours and then measuring the change in the optical density.

Optical density measurements can be performed using a Gretag spectrolino spectrophotometer set to the following parameters:

| | |
|---|---|
| Measuring Geometry | 45°/0° |
| Spectral Range | 380-730 nm |
| Spectral Interval | 10 nm |
| Illuminant | D65 |
| Observer | 2° (CIE 1931) |
| Density | Ansi A |
| External Filler | None |

Light and Ozone fastness may be assessed by the percentage change in the optical density of the print, where a lower figure indicates higher fastness, and the degree of fade. The degree of fade can be expressed as ΔE and a lower figure indicates higher light fastness. ΔE is defined as the overall change in the CIE colour co-ordinates L, a, b of the print and is expressed by the equation ΔE=(ΔL²+Δa²+Δb²)^{0.5}.

### Further Inks

Further inks may be prepared according to Tables A and B wherein the dye described in the second column is the dye made in the above example of the same number. Numbers quoted in the second column onwards refer to the number of parts of the relevant ingredient and all parts are by weight. The inks may be applied to paper by any form of ink-jet printing.

The following abbreviations are used in Tables A and B:

PG=propylene glycol

DEG=diethylene glycol

NMP=N-methyl pyrollidone

DMK=dimethylketone

IPA=isopropanol

MEOH=methanol

2P=2-pyrollidone

MIBK=methylisobutyl ketone

P12=propane-1,2-diol

BDL=butane-2,3-diol

CET=cetyl ammonium bromide

PHO=Na₂HPO₄ and

TBT=tertiary butanol

TDG=thiodiglycol

TABLE A

| | Dye | | | | | | | Na | | | | |
|---|---|---|---|---|---|---|---|---|---|---|---|---|
| Example | Content | Water | PG | DEG | NMP | DMK | NaOH | Stearate | IPA | MEOH | 2P | MIBK |
| 1 | 2.0 | 80 | 5 | | 6 | 4 | | | | | 5 | |
| 2 | 3.0 | 90 | | 5 | 5 | | 0.2 | | | | | |
| 3 | 10.0 | 85 | 3 | | 3 | 3 | | | | 5 | 1 | |
| 4 | 2.1 | 91 | | 8 | | | | | | | | 1 |
| 5 | 3.1 | 86 | 5 | | | | | 0.2 | 4 | | | 5 |
| 6 | 1.1 | 81 | | | 9 | | 0.5 | 0.5 | | | 9 | |
| 7 | 2.5 | 60 | 4 | 15 | 3 | 3 | | | 6 | 10 | 5 | 4 |
| 8 | 5 | 65 | | 20 | | | | | 10 | | | |
| 9 | 2.4 | 75 | 5 | 4 | | 5 | | | | 6 | | 5 |
| 10 | 4.1 | 80 | 3 | 5 | 2 | 10 | | 0.3 | | | | |
| 1 | 3.2 | 65 | | 5 | 4 | 6 | | | 5 | 4 | 6 | 5 |
| 1 | 5.1 | 96 | | | | | | | | 4 | | |
| 1 | 10.8 | 90 | 5 | | | | | | 5 | | | |
| 1 | 10.0 | 80 | 2 | 6 | 2 | 5 | | | 1 | | 4 | |
| 1 | 1.8 | 80 | | 5 | | | | | | | 15 | |
| 1 | 2.6 | 84 | | | 11 | | | | | | 5 | |
| 1 | 3.3 | 80 | 2 | | | 10 | | | | 2 | | 6 |
| 1 | 12.0 | 90 | | | | 7 | 0.3 | | 3 | | | |
| 1 | 5.4 | 69 | 2 | 20 | 2 | 1 | | | | | 3 | 3 |
| 1 | 6.0 | 91 | | | 4 | | | | | | 5 | |

TABLE B

| | Dye | | | | | | | | | | | |
|---|---|---|---|---|---|---|---|---|---|---|---|---|
| Example | Content | Water | PG | DEG | NMP | CET | TBT | TDG | BDL | PHO | 2P | Pl2 |
| 1 | 3.0 | 80 | 15 | | | 0.2 | | | | | 5 | |
| 2 | 9.0 | 90 | | 5 | | | | | | 1.2 | | 5 |
| 3 | 1.5 | 85 | 5 | 5 | | 0.15 | 5.0 | 0.2 | | | | |
| 4 | 2.5 | 90 | | 6 | 4 | | | | | 0.12 | | |
| 5 | 3.1 | 82 | 4 | 8 | | 0.3 | | | | | | 6 |
| 6 | 0.9 | 85 | | 10 | | | | | 5 | 0.2 | | |
| 7 | 8.0 | 90 | | 5 | 5 | | | 0.3 | | | | |
| 8 | 4.0 | 70 | | 10 | 4 | | | | 1 | | 4 | 11 |
| 9 | 2.2 | 75 | 4 | 10 | 3 | | | | 2 | | 6 | |
| 10 | 10.0 | 91 | | | 6 | | | | | | 3 | |
| 1 | 9.0 | 76 | | 9 | 7 | | 3.0 | | | 0.95 | 5 | |
| 1 | 5.0 | 78 | 5 | 11 | | | | | | | 6 | |
| 1 | 5.4 | 86 | | | 7 | | | | | | 7 | |
| 1 | 2.1 | 70 | 5 | 5 | 5 | 0.1 | 0.2 | 0.1 | 5 | 0.1 | 5 | |
| 1 | 2.0 | 90 | | 10 | | | | | | | | |
| 1 | 2 | 88 | | | | | | 10 | | | | |
| 1 | 5 | 78 | | | 5 | | | 12 | | | 5 | |
| 1 | 8 | 70 | 2 | | 8 | | | 15 | | | 5 | |
| 1 | 10 | 80 | | | | | | 8 | | | 12 | |
| 1 | 10 | 80 | | 10 | | | | | | | | |

1. A process for printing an image on a substrate by means of an ink-jet printer which comprises applying thereto a composition comprising a liquid medium and a disazo compound of Formula (1), or a salt thereof, or a dimer of said disazo compound of Formula (2), or a salt thereof: 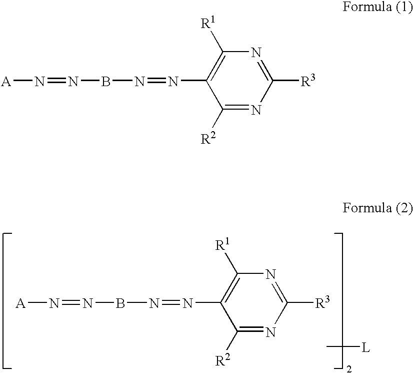
wherein:
A and B independently are optionally substituted aryl or optionally substituted heteroaryl groups;
R¹ and R² are each independently optionally substituted alkyl: halo: amino: NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl;
R³ is optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl; and
L is a divalent linking group that is covalently attached to A, B, R¹ or R³.

2. A process according to claim 1 wherein A and B independently are optionally substituted phenyl or optionally substituted napthyl.

3. A process according to claim 1 wherein A and B are independently selected from the group consisting of the following optionally substituted rings; pyrrolyl, furyl, thienyl, pyrazolyl, imidazolyl, triazolyl, thiazolyl, thiadiazolyl, pyridyl, pyrimidinyl or pyrazinyl.

4. A process according to claim 1 wherein A and/or B carry at least one water solubilising group.

5. A process according to claim 1 wherein A is optionally substituted phenyl or optionally substituted heteroaryl carrying at least one substituent selected from the group consisting of —S03H and —CO₂H.

6. A process according to claim 1 wherein B is optionally substituted phenyl or optionally substituted napthyl carrying at least one substituent selected from the group consisting of alkoxy, thioether, —PO₃H₂, —SO₃H and —CO₂H.

7. A process according to claim 1 where preferred phenyl and naphthyl groups represented by A and B are 2,5-disulfophenyl, 3,5-disulfophenyl, 1,5-disulfo-7-naphthyl, 1,3,6-trisulfo-7-naphthyl, 2-sulfo-4-methoxyphenyl, 2-sulfophenyl, 4-sulfophenyl and 3-sulfo-5-naphthyl.

8. A process according to claim 1 wherein R¹, R² and R³ are each independently: halo; amino; —NR⁴R⁵; wherein R⁴ is H, optionally substituted C₁₋₄alkyl, optionally substituted C₁₋₄alkoxy, optionally substituted C₁₋₄acyl, optionally substituted phenyl, optionally substituted heterocyclyl; and R⁵ is optionally substituted C₁₋₄alkyl, optionally substituted C₁₋₄alkoxy, optionally substituted C₁₋₄acyl, optionally substituted phenyl, optionally substituted heterocyclyl or R⁴ together with R⁵ and the nitrogen to which they are attached forms an optionally substituted 5 or 6 membered ring: —OR⁶; wherein R⁶ is H or optionally substituted C₁₋₄alkyl: or—SR⁷; wherein R⁷ is C₁₋₄alkyl.

9. A process according to claim 1 where R¹ is amino or —NR⁴R⁵; wherein R⁴ is H, optionally substituted C₁₋₄alkyl, optionally substituted C₁₋₄alkoxy, optionally substituted C₁₋₄acyl.

10. A process according to claim 1 where R² is amino; —NR⁴R⁵; wherein R⁴ is H, optionally substituted C₁₋₄alkyl, optionally substituted C₁₋₄alkoxy, optionally substituted C₁₋₄acyl; —OR⁶, wherein R⁶ is H or optionally substituted C₁₋₄alkyl; —SR⁷, wherein R⁷ is C₁₋₄alkyl; or chloro.

11. A process according to claim 1 where R³ is amino; —NR⁴R⁵; wherein R⁴ is H, optionally substituted C₁₋₄alkyl, optionally substituted C₁₋₄alkoxy, optionally substituted C₁₋₄acyl; —OR⁶, wherein R⁶ is H or optionally substituted C₁₋₄alkyl; —SR⁷, wherein R⁷ is C₁₋₄alkyl; or chloro.

12. A process according to claim 1 where L is selected from the group comprising: divalent alkyl; divalent aryl; divalent heterocyclyl; —CO—; —NHCONH—; a group of formula: —CO—R⁹—CO—; —CO—NH—R⁹—NH—CO—; —SO₂—R⁹—SO₂—; —SO₂—NH—R⁹—NH—SO₂—; or —NR¹⁰—R⁹—NR¹⁰—; wherein R⁹ is divalent alkylene or divalent arylene optionally bearing substituents selected from the group comprising alkoxy, sulfo, carboxy, hydroxy and amino and R¹⁰ is H, alkyl, aryl or heterocyclyl optionally bearing a substituent selected from the group comprising alkoxy, sulfo, carboxy, hydroxy and amino.

13. A composition comprising a compound of Formula (1) or Formula (2), as defined in claim 1, or a salt thereof and a liquid medium which comprises a mixture of water and organic solvent or organic solvent free from water.

14. A composition according to claim 13 which is ink suitable for use in an ink-jet printer.

15. A disazo compound of Formula (1) and salts thereof: 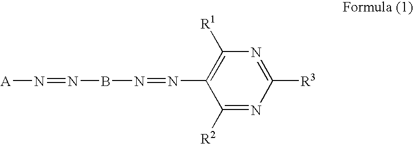
wherein:
A and B independently are optionally substituted aryl or optionally substituted heteroaryl groups wherein both A and B independently carry at least one water solubilising substituent selected from the group consisting of—SO₃H, —CO₂H, —PO₃H₂, and alkoxy: and
R¹ and R² are each independently optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl;
R³ is optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is optionally substituted alkyl: or —SR⁷; wherein R⁷ is optionally substituted alkyl;
provided that the compound is not of the formula

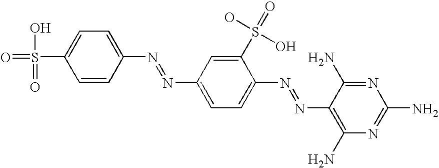

16. A composition comprising a compound of Formula (1), as defined in claim 15, or a salt thereof and water.

17. A compound of Formula (2) and salts thereof: 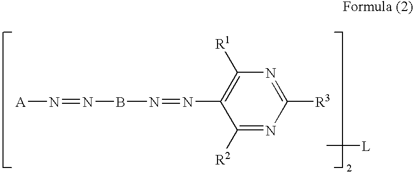
wherein:
A and B independently are optionally substituted aryl or optionally substituted heteroaryl groups;
R¹ and R² are each independently optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is H or optionally substituted alkyl: or —SR⁷; wherein R⁷ is optionally substituted alkyl;
R³ is optionally substituted alkyl: halo: amino: —NR⁴R⁵; wherein R⁴ is H, optionally substituted alkyl, optionally substituted alkoxy, optionally substituted acyl, optionally substituted aryl, optionally substituted heterocyclyl; and R⁵ is optionally substituted alkyl, optionally substituted alkoxy, optionally substituted acyl, optionally substituted aryl, optionally substituted heterocyclyl or R⁴ together with R⁵ and the nitrogen to which they are attached forms an optionally substituted 5 or 6 membered ring: —OR⁶; wherein R⁶ is optionally substituted alkyl: or —SR⁷; wherein R⁷ is optionally substituted alkyl; and
L is a divalent linking group that is covalently attached to A, B, R¹ or R³.

18. A composition comprising a compound of Formula (2), as defined in claim 17, or a salt thereof and water.

19. A material printed with a compound as described in claim 15, or a salt thereof, a composition as described in claim 13 or by means of a process as described in claim 1.

20. A material according to claim 19 that is a print on a photographic quality paper printed using a process as described in claim 1.

21. An ink-jet printer cartridge comprising a chamber and an ink suitable for use in an ink-jet printer wherein the ink is in the chamber and the ink is as defined in claim 13.
